(19) United States
(12) Patent Application Publication
(10) Pub. No.: US 2005/0198089 A1
(43) Pub. Date: Sep. 8, 2005

(54) Mixed-scaling-rotation CORDIC method with scaling-free rotational operations for vector rotation

(75) Inventors: Chih-Hsiu Lin, Jiaosi Township (TW); An-Yeu Wu, Taipei City (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 10/793,920

(22) Filed: Mar. 8, 2004

(51) Int. Cl. G06F 7/00

(52) U.S. Cl. 708/200

(57) ABSTRACT

A method of mixed-scaling-rotation CORDIC (MSR-CORDIC) with scaling-free rotational operations is disclosed. An elementary angles set is extended by representing the elementary angles as the arctangent of the division of two single signed-power-of-two terms to an enhanced extended elementary angles set. A combination of elementary angles is found from the enhanced extended elementary angles set such that the residue angle error can be minimized. A MSR-CORDIC operation is used to perform the rotating and scaling transformation simultaneously.

### BACKGROUND OF THE INVENTION

1. Field of the Invention

The present invention relates to a COordinate Rotational DIgital Computer (CORDIC) method, and more particularly, to a mixed-scaling-rotation CORDIC method with scaling-free rotational operations applied in a vector rotator for performing vector rotations.

2. Description of Related Art

Currently, the vector rotation is known to be the kernel of various digital signal processing applications, including discrete orthogonal transformations, lattice-based digital filtering, matrix computation, complex-valued number manipulation, etc. In X-Y coordinates, one vector rotation operation can be expressed as:

$$[ \begin{matrix}{x}_{out} \\ {y}_{out}\end{matrix} ] = [ \begin{matrix}cos θ & - sin θ \\ sin θ & cos θ\end{matrix} ] \cdot [ \begin{matrix}{x}_{in} \\ {y}_{in}\end{matrix} ]$$

FIG. 1 shows a hardware architecture used to implement the vector rotation operation, which requires four adders and two multipliers. That is, the execution of one vector rotation operation will require executing four addition operations and two multiplication operations. The complexity of such an execution is too high. Reducing the wordlength can decrease the complexity. However, the SQNR will be increased accordingly.

The CORDIC algorithm is a well-known iterative method for the computation of vector rotation, which requires only one shift operation and one addition operation to perform a vector rotation operation. The CORDIC algorithm decomposes the rotation angle θ into a combination of pre-defined elementary angles as follows:

$$θ = {\sum }_{i = 0}^{N - 1} μ ( i ) a ( i ) + ɛ , \qquad ( 1 )$$

where N is the number of elementary angles, μ={1, −1} is the rotation sequence which determines the direction of the i-th elementary angle of a(i)=tan⁻¹(2⁻ⁱ), and ε denotes the residue angle.

Based on equation (1), the recurrence equations of the CORDIC algorithm can be written as

$$\{ \begin{matrix}x ( i + 1 ) = x ( i ) - μ ( i ) y ( i ) {2}^{- i} \\ y ( i + 1 ) = y ( i ) + μ ( i ) x ( i ) {2}^{- i}\end{matrix} , \qquad ( 2 )$$

for i=0, 1, . . . , N−1. In practical fixed-point implementation, for data wordlength of W bits, no more than W iterations of the recurrence relation in equation (2) need be performed, i.e., N≦W. Also, the final values, x(N) and y(N), need to be scaled by an accumulated scaling factor expressed as follows:

$$P = {( {\prod }_{i = 0}^{N - 1} \sqrt{1 + {2}^{- 2 i}} )}^{- 1} . \qquad ( 3 )$$

In the above CORDIC algorithm, each elementary angle needs to be performed sequentially so as to complete the micro-rotation phase. However, in the applications where the rotation angles are known in advance, it would be advantageous to relax the sequential constraint on the micro-rotation phase. The angle recoding (AR) technique is done by extending the set of μ (i) from {1, −1} to {1, −1, 0}. By substituting μ(i)=0 into equation (2), one can skip the micro-rotation of the elementary angle a(i)=tan⁻¹(2⁻ⁱ). Nevertheless, the AR technique imposes no restriction on the iteration number. Rotation angles of different values may need unequal numbers of iterations, which may lead to bus/timing alignment problems in VLSI circuits. Moreover, in certain applications, such as the twiddle factors in FFT, the rotation angles are larger than π/4. Therefore, it is difficult for the conventional CORDIC to perform such a rotation angle.

In U.S. publication 20030097388 for a “CORDIC method and architecture applied in vector rotation” provided to reduce the iteration to accelerate the computational speed by making modifications on the rotation procedure, the elementary angle is extended to extend elementary angle as follows:

$$θ ∈ arctan ( {\sum }_{i = 1}^{I} {μ}_{i} {2}^{- {s}_{i}} ) , \qquad ( 4 )$$

where I is defined as the Extending Factor and denotes the number of Singed Power-of-Two (SPT) terms, sₙε{0,1, . . . ,S}, (S denotes the number of maximum shift). The scaling function is written as:

$$P = {\prod }_{n} {p}_{n} \\ {p}_{n} = \sqrt{1 + {( {\sum }_{i = 1}^{I} {2}^{- {s}_{i}} )}^{2}} , \qquad ( 5 )$$

where pₙ is the n-th iteration-scaling factor. The equation shows that the scaling factors are different, corresponding to each rotation angle. That is, in order to perform the forward rotation, the scaling factors of all rotation angles are computed off-line, and the pre-computed parameters are stored in ROM in practical applications. Such an improved CORDIC method, known as EEAS (extended elementary angles set)-CORDIC algorithm, utilizes a pre-rotation strategy to overcome the aforementioned problem and improves the performance. However, one extra multiplexer is needed to execute the exchange of two input vectors. Further, in addition to the extra hardware cost, the computing speed will be also decreased due to the delay of the multiplexer. Therefore, it is desired for the above CORDIC method to be improved to mitigate and/or obviate the aforementioned problems.

### SUMMARY OF THE INVENTION

The object of the present invention is to provide a mixed-scaling-rotation CORDIC method with scaling-free rotational operations for vector rotation.

In accordance with one aspect of the present invention, the mixed-scaling-rotation CORDIC method with scaling-free rotational operations comprises the steps of: generating plural shifted components by using pre-computed and pre-stored parameters; and performing a pre-determined iteration number of shifting operations to rotate an input point to a destination point with a predefined rotation angle based on the plural shifted components.

In accordance with another aspect of the present invention, there is provided a mixed-scaling-rotation CORDIC method with scaling-free rotational operations. In the method, an elementary angles set is extended as:
S₁={tan⁻¹(a¹*2^{-s}′): a′ε{−1,0,1},s′ε{0,1, . . . ,N−1}},
by representing the elementary angles as the arctangent of the division of two single signed-power-of-two (SPT) terms (a′*2^{-s}′) to an enhanced extended elementary angles set:

$${s}_{2} = \{ {tan}^{- 1} ( \frac{{\sum }_{i = 1}^{I} {μ}_{i} {2}^{- {s}_{i}}}{{\sum }_{j = 1}^{J} {μ}_{j} {2}^{- {s}_{j}}} ) : {μ}_{i} , {μ}_{j} ∈ \{ - 1 , 0 , 1 \} , {s}_{n} ∈ \{ 0 , 1 , … , S \} \} ,$$

where S denotes the number of maximum shift. Next, a combination of parameters μᵢ,sᵢ is found to maximize SQNR performance, where the SQNR is defined as:

$$SQNR = \frac{{( Singal Power )}^{2}}{{( Quantization Error )}^{2}} .$$

Finally, plural (Quantization Error)² F micro-rotation of 2^{-s}^{ᵢ} and 2^{-s}^{ⱼ} are used to perform the rotating and scaling transformation simultaneously.

Other objects, advantages, and novel features of the invention will become more apparent from the following detailed description when taken in conjunction with the accompanying drawings.

### BRIEF DESCRIPTION OF THE DRAWINGS

FIG. 1 shows a conventional hardware architecture for implementing vector rotation;

FIG. 2 is the flowchart of the method for mixed-scaling-rotation CORDIC with scaling-free rotational operations in accordance with the present invention;

FIG. 3 shows constellation of reachable points under the rotation process of the conventional technology and the present invention;

FIG. 4 shows configurations of the mixed-scaling-rotation CORDIC with Nspt=3 in accordance with the present invention; and

FIG. 5 shows the hardware structure of normal type II for the normal mixed-scaling-rotation CORDIC with Nspt=3, I=2 and J=1 in accordance with the present invention.

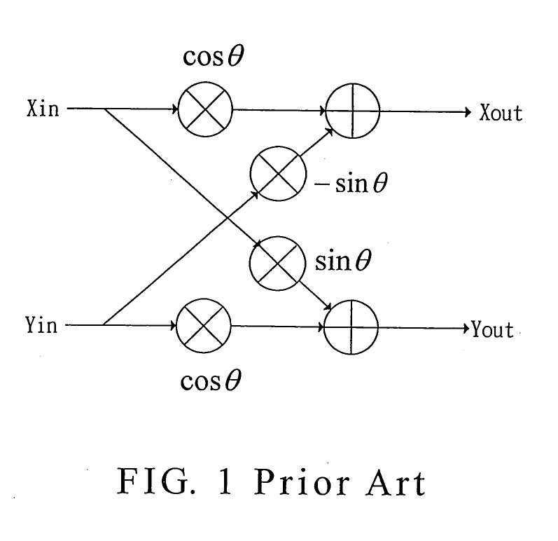

### DETAILED DESCRIPTION OF THE PREFERRED EMBODIMENT

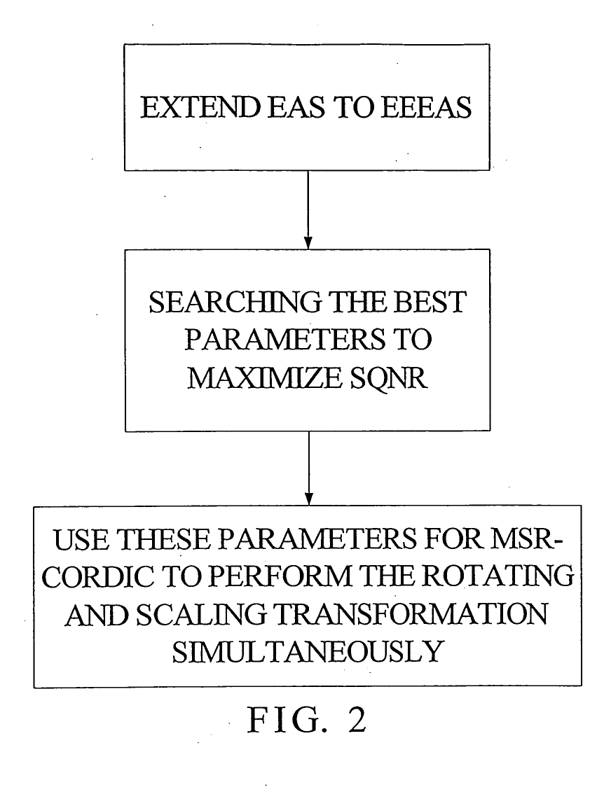

FIG. 2 shows the flowchart of the mixed-scaling-rotation CORDIC (MSR-CORDIC) method with scaling-free rotational operations in accordance with the present invention. As shown, the present method includes the following three stages: (S1) extending the elementary angle set (EAS) to an enhanced extended elementary angle set (EEEAS) for executing the CORDIC algorithm; (S2) searching the best combinations of the parameters, μᵢ,sᵢ, to maximize the SNQR. (S3) using these parameters for Mixed-Scaling-Rotation CORDIC (MSR-CORDIC) operation to perform the rotating and scaling transformation simultaneously.

To facilitate the derivation of the present EEEAS scheme, the reformulation is done by removing the redundant iterations of μ(i)=0 in conventional CORDIC algorithm, changes the variables and index, and use the equality ±tan⁻¹(A)=tan⁻¹(±A). It is seen that the EAS S1 is comprised of an arctangent of single signed-power-of-two (SPT) term, i.e., tan⁻¹(a′*2^{-s}′). By representing the elementary angles as the arctangent of the division of two SPT terms, the EAS S₁ can be extended to an enhanced extended elementary angles set (EEEAS) S₂ as follows:

$${s}_{2} = \{ {tan}^{- 1} ( \frac{{\sum }_{i = 1}^{I} {μ}_{i} {2}^{- {s}_{i}}}{{\sum }_{j = 1}^{J} {μ}_{j} {2}^{- {s}_{j}}} ) : {μ}_{i} , {μ}_{j} ∈ \{ - 1 , 0 , 1 \} , {s}_{n} ∈ \{ 0 , 1 , … , S \} \} , \qquad ( 6 )$$

where S denotes the number of maximum shift.

Based on the EEEAS S₂ obtained in equation (6), the recurrence equations of the CORDIC algorithm can be modified as:

$$\begin{matrix}[ \begin{matrix}x ( n + 1 ) \\ y ( n + 1 )\end{matrix} ] = [ \begin{matrix}{\sum }_{j = 1}^{J} {μ}_{j} {2}^{- {s}_{j}} & - {\sum }_{i = 1}^{I} {μ}_{i} {2}^{- {s}_{i}} \\ {\sum }_{i = 1}^{I} {μ}_{i} {2}^{- {s}_{i}} & {\sum }_{j = 1}^{J} {μ}_{j} {2}^{- {s}_{j}}\end{matrix} ] [ \begin{matrix}x ( n ) \\ y ( n )\end{matrix} ] , & ( 7 ) \\ {θ}_{n + 1} = {tan}^{- 1} ( \frac{{\sum }_{i = 1}^{I} {μ}_{i} {2}^{- {s}_{i}}}{{\sum }_{j = 1}^{J} {μ}_{j} {2}^{- {s}_{j}}} ) , & ( 8 ) \\ z ( n + 1 ) = z ( n ) + {θ}_{n + 1} , & ( 9 ) \\ {p}_{n + 1} = ( \sqrt{{\sum }_{i = 1}^{I} {( {2}^{- {s}_{i}} )}^{2}} ) ( \sqrt{{\sum }_{j = 1}^{J} {( {2}^{- {s}_{j}} )}^{2}} ) , & ( 10 ) \\ \overline{{p}_{n + 1}} = \overline{{p}_{n}} \times {p}_{n + 1} , & ( 11 )\end{matrix}$$

where μᵢ,μⱼε{−1,0,1}, I and J are the number of SPT terms of x(n) and y(n) respectively and are referred to as the Extending Factor, θₙ is the elementary angle and the initial value,\overline{pₙ₊₁} is the product of the scaling factors in n-th iteration, and initial value of \overline{p₁} is 1, Nspt is the number of SPT terms used in performing equation (7) and is the sum of I and J, N is the total number of iteration, and Sₙε{0,1, . . . , S} and S denotes the number of maximum shift. For 0≦N≦Rₘ−1,

$${\sum }_{j = 1}^{J} {μ}_{j} {2}^{- {s}_{j}} , - {\sum }_{i = 1}^{I} {μ}_{i} {2}^{- {s}_{i}} , {\sum }_{i = 1}^{I} {μ}_{i} {2}^{- {s}_{i}} and {\sum }_{j = 1}^{J} {μ}_{j} {2}^{- {s}_{j}}$$

denote the parameters to control the N-th micro-rotation of the elementary angle of

$${tan}^{- 1} ( \frac{{\sum }_{i = 1}^{I} {μ}_{i} {2}^{- {s}_{i}}}{{\sum }_{j = 1}^{J} {μ}_{j} {2}^{- {s}_{j}}} ) .$$

In the second stage, with the above EEEAS S₂ and given θ and Rₘ, it is desired to find the parameters of

$${\sum }_{j = 1}^{J} {μ}_{j} {2}^{- {s}_{j}} , - {\sum }_{i = 1}^{I} {μ}_{i} {2}^{- {s}_{i}} , {\sum }_{i = 1}^{I} {μ}_{i} {2}^{- {s}_{i}} and {\sum }_{j = 1}^{J} {μ}_{j} {2}^{- {s}_{j}}$$

(i.e., the combination of elementary angles from EEEAS S₂), such that the SQNR is maximized.

In the third stage of processing, the MSR-CORDIC operation, as equation (7), is used to perform the rotating and scaling transformation simultaneously.

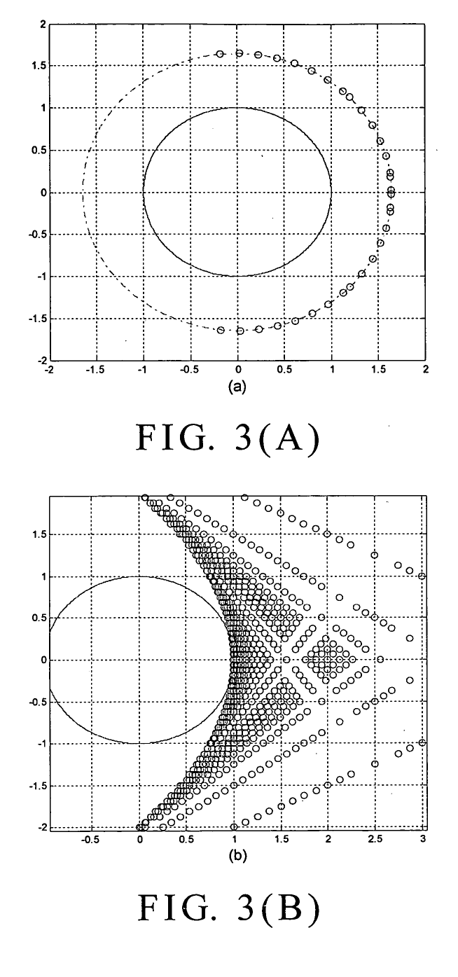

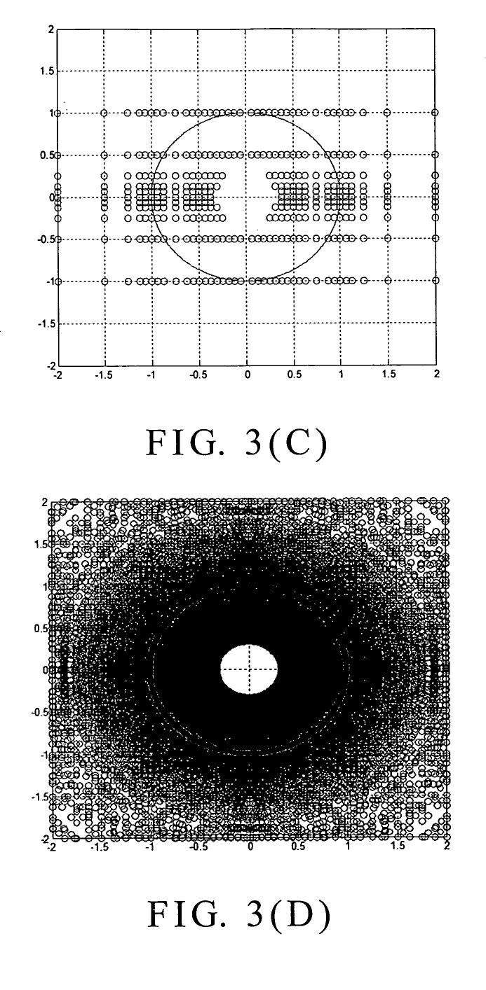

From equations (7)-(11), it shows that the x(n+1) and y(n+1) are rotated and scaled simultaneously in one iteration. In the conventional CORDIC and EEAS-CORDIC algorithms, the norms of both schemes are enlarged after the micro-rotation operations. That is, the norm is amplified as illustrated in FIG. 3(A) and FIG. 3(B). On the contrary, in the present MSR-CORIDC operation, equation (10) shows that the factor pn can be either greater or less than 1, and thus it needs not to perform the micro-rotation operation and scaling operations separately. FIG. 3(C) shows that the reachable points in 2-D plane to emphasize the feature of pₙ.

According to the equation (8), the angles in the MSR-CORDIC is much denser than conventional CORDIC and EEAS-CORDIC algorithms. Hence, the MSR-CORDIC operation can reach the target angle with less iteration number. When performing the MSR-CORDIC operation twice or more, the combinational points are very dense around the unit circle. As shown in FIG. 3(D), the MSR-CORDIC operation is executed by two iterations (N=2). Furthermore, if the parameters sᵢ,μⱼ are designed appropriately so that both the quantization error of rotation angles and norms meet the system performance requirement at the same time, the scaling operation can be avoid. Since no extra scaling operation is required, the MSR-CORDIC operation is faster in computational speed and the corresponding hardware cost can be reduced dramatically.

As shown in the FIG. 3(D), the reachable angles are distributed from 0 to 2π, it is easier to perform the rotation operation for all angles in [0, 2π] without performing the pre-rotation scheme, thereby alleviating the hardware requirement for conventional CORDIC to perform the rotation angles great than π/4.

To implement the aforementioned method, the iteration equation (7) is reformulated as follow:

$$\begin{matrix}x ( n + 1 ) = {\sum }_{j = 1}^{J} {μ}_{j} {2}^{- {s}_{j}} x ( n ) - {\sum }_{i = 1}^{I} {μ}_{i} {2}^{- {s}_{i}} y ( n ) , & ( 12 ) \\ y ( n + 1 ) = {\sum }_{i = 1}^{I} {μ}_{i} {2}^{- {s}_{i}} x ( n ) + {\sum }_{j = 1}^{J} {μ}_{j} {2}^{- {s}_{j}} y ( n ) . & ( 13 )\end{matrix}$$

In the equations (12) and (13), it shows that both of x(n+1) and y(n+1) are linear combination of their prior x(n) and y(n). All coefficients of x(n) and y(n) are power of two numbers with the sign μᵢ and μⱼ, respectively. Thus, two Barrel Shifter Arrays (BSAs) are used to perform shifting operations. For each BSA, it outputs Nspt shifted components 2^{-s0}x(n), 2^{-s1}x(n), . . . 2^{-sN-1}x(n) and 2^{s0}y(n), 2^{-s1}y(n), . . . 2s^{-sN-1}y(n) respectively. Thus, it needs 2(Nspt−1) add/subtract operations to sum the outputs of each BSA and 2(Nspt−1) adders/subtractors are used to perform such operation in one clock cycle.

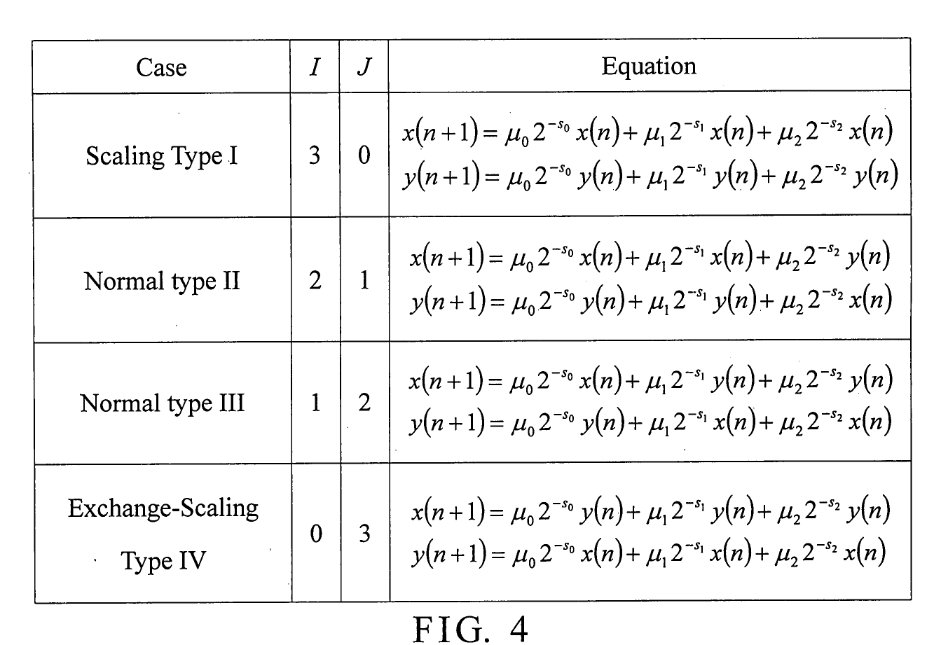

FIG. 4 shows configurations of the MSR-CORDIC with Nspt=3, which can be classified into 4 types with different values of I and J, respectively. In the scaling type I (I=3, J=0), x(n+1) and y(n+1) are the sum of the shifted version of their each preceding value x(n) and y(n), respectively. In the exchange-scaling type IV (I=0, J=3), x(n+1) and y(n+1) are the sum of their shifted preceding values. In this type, two kinds of operations are performed in one iteration, including the scaling operation and the exchange of x(n+1) and y(n+1), which induces a rotation of angle π/2.

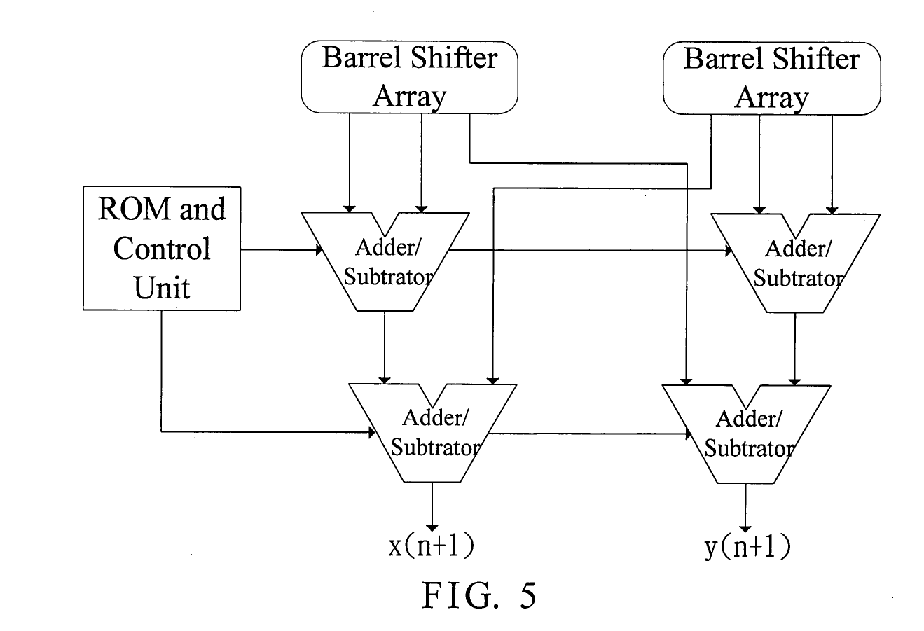

The normal type II (I=2, J=1) and normal type III (I=1, J=2) MSR-CORDIC can implement the rotation circuits individually. The hardware cost and computational speed are the same. However, they perform the different SQNR performances. FIG. 5 illustrates the structure of normal type II MSR-CORDIC with Nspt=3, I=2 and J=1. The ROM and control unit is used to control BSAs and adders/subtractors to operate in accordance with the aforementioned MSR-CORDIC operation.

In view of the foregoing, it is known that the MSR-CORDIC operation not only can perform the rotation and scaling simultaneously but also can alleviate the hardware requirement to perform the rotation angles great than π/4.

Although the present invention has been explained in relation to its preferred embodiment, it is to be understood that many other possible modifications and variations can be made without departing from the spirit and scope of the invention as hereinafter claimed.

1. A mixed-scaling-rotation CORDIC method with scaling-free rotational operations, comprising the steps of:
generating plural shifted components by using pre-computed and pre-stored parameters; and
performing a pre-determined iteration number of shifting operations to rotate an input point to a destination point with a predefined rotation angle based on the plural shifted components.

2. The method as claimed in claim 1, wherein in the step of generating plural shifted components, the generated plural shifted components are: 2^{-s0}x(n), 2^{-s1}x(n), . . . 2^{-sN-1}x(n), 2^{-s0}y(n), 2^{-s0}y(n), . . . . 2^{-sN-1}y(n), where N is the pre-determined iteration number of shifting operations, (x(n), y(n)) is the input point and (x(n+1), y(n+1)) is the destination point.

3. The method as claimed in claim 2, wherein in the step of performing shifting operations, the destination point (x(n+1), y(n+1)) is computed based on the plural shifted components as:
$$x ( n + 1 ) = {\sum }_{j = 1}^{J} {μ}_{j} {2}^{- {s}_{j}} x ( n ) - {\sum }_{i = 1}^{I} {μ}_{i} {2}^{- {s}_{i}} y ( n ) and$$
$$y ( n + 1 ) = {\sum }_{i = 1}^{I} {μ}_{i} {2}^{- {s}_{i}} x ( n ) + {\sum }_{j = 1}^{J} {μ}_{j} {2}^{- {s}_{j}} y ( n ) ,$$
where μᵢ, μⱼε{−1,0,1}, I and J denote the number of SPT terms of x(n) and y(n), respectively, Nspt is the sum of the number of SPT term of I and J.

4. The method as claimed in claim 3, wherein in the step of performing shifting operations, the shifting operation is a Barrel shifting operation.

5. The method as claimed in claim 3, wherein in the step of performing shifting operations, Nspt is equal to 3, J=3, I=0, the component x(n+1) of the destination point is equal to μ₀2^{-s}^{₀}x(n)+μ₁2^{-s}^{₁}x(n)+μ₂2^{-s}^{₂}x(n), and the component y(n+1) of the destination point is equal to μ₀2^{-s}^{ᵢ}y(n)+μ₂^{-s}^{₂}y(n)+μ₂2^{-s}^{₂}y(n).

6. The method as claimed in claim 3, wherein in the step of performing shifting operations, Nspt is equal to 3, J=2, I=1, the component x(n+1) of the destination point is equal to μ₀2^{-s}^{₀}x(n)+μ₁2^{-s}^{₁}x(n)+μ₂2^{-s}^{₂}y(n), and the component y(n+1) of the destination point is equal to μ₀2^{-s}^{₀}y(n)+μ₁2^{-s}^{₁}y(n)+μ₂2^{-s}^{₂}x(n).

7. The method as claimed in claim 3, wherein in the step of performing shifting operations, Nspt is equal to 3, J=1, 1=2, the component x(n+1) of the destination point is equal to μ₀2^{-s}^{₀}x(n)+μ₁2^{-s}^{₁}x(n)+μ₂2^{-s}^{₂}y(n), and the component y(n+1) of the destination point is equal to μ₀2^{-s}^{₀}y(n)+μ₁2^{-s}^{₁}x(n)+μ₂2^{-s}^{₂}x(n).

8. The method as claimed in claim 3, wherein in the step of performing shifting operations, Nspt is equal to 3, J=0, I=3, the component x(n+1) of the destination point is equal to μ₀2^{-s}^{₀}y(n)+μ₁2^{-s}^{₁}x(n)+μ₂2^{-s}^{₂}y(n), and the component y(n+1) of the destination point is equal to μ₀2^{-s}^{₀}x(n)+μ₁2^{-s}^{₁}x(n)+μ₂2^{-s}^{₂}x(n).

9. A mixed-scaling-rotation CORDIC method with scaling-free rotational operations comprising the steps of:
extending an elementary angles set:
S₁={tan⁻¹(a′*2^{-s′}):a′ε{−1,0,1},s′ε{0,1, . . . ,N−1}}
by representing the elementary angles as the arctangent of the division of two single signed-power-of-two (SPT) terms (a′*2^{-s′}) to an enhanced extended elementary angles set:
$${s}_{2} = \{ {tan}^{- 1} ( \frac{{\sum }_{i = 1}^{I} {μ}_{i} {2}^{- {s}_{i}}}{{\sum }_{j = 1}^{J} {μ}_{j} {2}^{- {s}_{j}}} ) : {μ}_{i} , {μ}_{j} ∈ \{ - 1 , 0 , 1 \} , {s}_{n} ∈ \{ 0 , 1 , … , S \} \} ,$$
where S denotes the number of maximum shift;
finding a combination of parameters μᵢ,sᵢ to maximize SQNR performance;
using plural micro-rotation of 2^{s}^{ᵢ} and 2^{-s}^{ⱼ} to perform the rotating and scaling transformation simultaneously.

10. The method as claimed in claim 9, wherein, based on the enhanced extended elementary angles, the CORDIC method is performed by the recurrence equations:
$$[ \begin{matrix}x ( n + 1 ) \\ y ( n + 1 )\end{matrix} ] = [ \begin{matrix}{\sum }_{j = 1}^{J} {μ}_{j} {2}^{- {s}_{j}} & - {\sum }_{i = 1}^{I} {μ}_{i} {2}^{- {s}_{i}} \\ {\sum }_{i = 1}^{I} {μ}_{i} {2}^{- {s}_{i}} & {\sum }_{j = 1}^{J} {μ}_{j} {2}^{- {s}_{j}}\end{matrix} ] [ \begin{matrix}x ( n ) \\ y ( n )\end{matrix} ] ,$$
where μᵢ, μⱼε{−1,0,1}, I and J denote the number of SPT terms of x(n) and y(n), respectively, Nspt is the sum of the number of SPT term of I and J.
